(19) United States
(12) Patent Application Publication
(10) Pub. No.: US 2007/0221658 A1
(43) Pub. Date: Sep. 27, 2007

(54) Electric heating element

(76) Inventors: Elizabeth Cates, Duncan, SC (US); Alfred R. Deangelis, Spartanburg, SC (US)

Correspondence Address: Legal Department (M-495), P.O. Box 1926, Spartanburg, SC, 29304, US

(21) Appl. No.: 11/389,941

(22) Filed: Mar. 27, 2006

(51) Int. Cl. H05B 3/34

(52) U.S. Cl. 219/529

(57) ABSTRACT

The invention relates to an electric heating element comprising a conductive fabric, a patterned conductive layer on at least a first side of the conductive fabric, and at least 2 buses on the conductive fabric, wherein the patterned conductive layer is disposed between the buses.

### FIELD OF THE INVENTION

The present invention refers to an electric heating element, more particularly a heating element to be used, e.g., for heatable garments such as gloves.

### BACKGROUND

In electrically heated textiles, it is often desirable to have the heat distribution tailored so that different amounts of heat (different power densities) are generated in different regions of the article.

Heat generation (or power density) is a function of voltage, current, and resistance. One method of controlling heat generation is to change the applied voltage. While it is straightforward to change the total power generated by an article by changing the total applied voltage, changing the relative applied voltage within an article is usually prohibitively difficult or expensive. Therefore, to tailor the heat generation to be different at different points within a single article, it is usually easiest to change the current flow, or equivalently the resistance, in each region.

Resistance is a function of the geometry and material conductivity of the conducting path, R=(ρ*L)/(W*t)=r (L/W), where ρ is the resistivity of the material (a material property), t is the thickness of the region through which the current flows, r=ρ/t is the surface resistance of the conducting path, L is its length, and W is its width. The material may be a combination of conductive component materials, in which case the resistivity is a combination of the resistivities of the individual component materials.

The surface geometry of the conducting path is often fixed, or at least highly constrained, by the dimensions of the article. In this case, heat generation can be best controlled by altering the surface resistance of the conductive path. It is often desirable to minimize thickness to minimize the effects of the conductive material on the physical properties of the article, so that modifying the resistivity may be the preferred method of altering the surface resistance. However, in some cases the same effect can be accomplished by changing the thickness of the conductive material.

One method of tailoring surface resistance is to apply a conductive coating to regions of a non-conductive fabric. However, conductive pastes and coatings can be brittle and are usually capable of less stretch than the underlying fabric, so that when used on a flexible article such as a textile they are prone to cracking. These cracks interrupt the current flow, increasing the resistance of the region and reducing the heat generation. In severe cases the conductive coating becomes discontinuous, and the article stops generating heat in the affected region or possibly (depending on the layout of the circuit) in the entire article.

Another method of tailoring surface resistance is to incorporate conductive yarns or wires into the fabric. In this way, conductive fabrics with most or all of the normally desirable attributes of a fabric (drape, hand, stretch, flexibility, permeability, etc.) can be maintained. With proper design, the conductivity can be made robust to flexing and stretching. A great disadvantage is the difficulty, if not impossibility, of tailoring the shape of the conductive region beyond simple rectangles and strips.

There is a need for a defect-tolerant and failure-tolerant electrically heating textile in which surface resistance and hence heat generation may be easily tailored across the textile.

### BRIEF DESCRIPTION OF THE DRAWINGS

An embodiment of the present invention will now be described by way of example, with reference to the accompanying drawings.

FIG. 1 is a view of one embodiment of the electrical heating element where the electric heating element is a flat garment, such as a blanket.

FIGS. 2a, 2b, and 2c show embodiments of the invention illustrating the effects of areas of lower resistivity on the heated element.

FIGS. 3A and 3B are front and back views of one embodiment of the electrical heating element where the electric heating element is a glove.

FIG. 4 is a graph showing the surface resistance of examples subjected to stretching.

### DETAILED DESCRIPTION

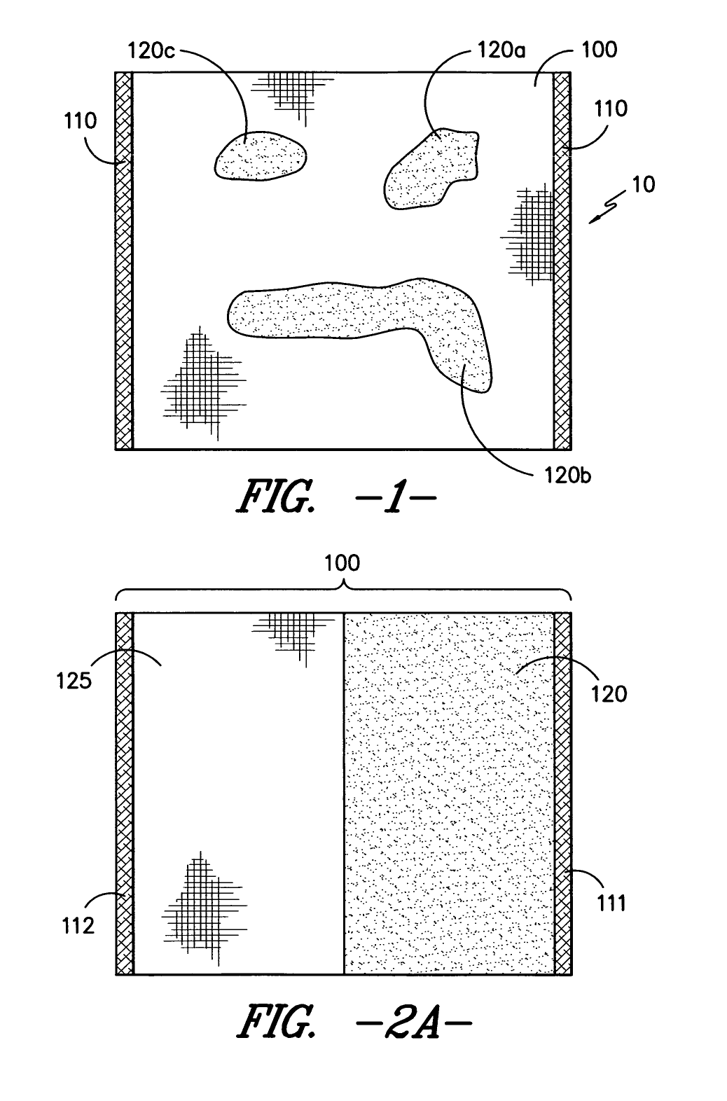

Referring now to FIG. 1, there is shown an electric heating article 10 that may be, for example, a heated blanket. Electric heating article 10 includes a conductive fabric 100, at least two buses 110, and a patterned conductive layer 120 on at least one side of the conductive fabric 100. The patterned conductive layer 120 (formed of 120a, 120b, and 120c) is located between the two buses 110. The patterned conductive layer 120 creates regions of differing resistivity across the conductive fabric 100.

The electric heated article 10 permits the facile alteration of heat distribution in an electrically conducting textile and creates a failure-tolerant electrically-heated textile. The underlying conductive fabric combined with the conductive coating creates a conductive system more robust to flexing and stretching than if the fabric were not conductive. The invention provides a means for tailoring the level and region of conductivity of a fabric. When an electric voltage is applied between the buses, areas of the conductive textile with lower surface resistance generate different (localized) heat than other areas. The conductive coating may also change the heat generation in surrounding areas by changing the current flow.

In one example, the conductive fabric 100 is constructed using conductive yarns so as to have a surface resistivity r0, while patterned conductive layer 120a has surface resistivity r1<r0. At the same time, patterned conductive layer 120b may be constructed with surface resistivity r2<r1, and patterned conductive layer 120c can have a surface resistivity that varies over its area, for example, by changing the thickness of the conductive layer from one place to another. In fact, the resistivities of the patterned conductive areas can be in any relation to the resistivities of the fabric and each other, and they can vary or not within a continuous region of a patterned conductive area.

By combining patterned conductive layers with conductive fabrics, articles can be manufactured having robust conductivity that is tailored to the application. This method is particularly suited to irregularly shaped objects, such as gloves, because the electric heated article 10 is easily tailored to include irregularly shaped regions with different conductivities. This permits the development of sophisticated devices. Both the shape and conductivity of these regions can be easily controlled by varying coating materials, patterns, or thicknesses. Applying a patterned conductive layer 120 to a conductive fabric 100 permits the use of one conductive textile base for a variety of applications, whereas other methods of creating patterned electrically conductive textiles create products that are unique to singular applications.

The electric heated article 10 may be formed into heated garments, such as jackets, sweaters, hats, gloves, shirts, pants, socks, boots, and shoes, and into home furnishing textile articles, such as blankets, mattresses or mattress covers, throws, warming pads, warming mats, and seat warmers.

The electrically conductive fabric 100 may be of any stitch construction suitable to the end use, including by not limited to woven, knitted, non-woven, and tufted textiles, or the like.

Woven textiles can include, but are not limited to, satin, twill, basket-weave, poplin, and crepe weave textiles. Jacquard woven structures may be useful for creating more complex electrical patterns. Knit textiles can include, but are not limited to, circular knit, reverse plaited circular knit, double knit, single jersey knit, two-end fleece knit, three-end fleece knit, terry knit or double loop knit, warp knit, and warp knit with or without a microdenier face.

The textile may be flat or may exhibit a pile. The conductivity of the electrically conductive fabric 100 will vary according to the end use. In one embodiment where the electric heating element 10 is used as a heating garment, such as a glove, the surface resistance of the electrically conductive fabric 100 may be approximately 0.1 to 100 ohms. The fabric should be conductive on an exposed surface in order to electrically connect with the conductive buses 110 and the patterned conductive layer 120.

In one embodiment, the conductive fabric 100 is composed fully or partially of conductive fibers or yarns. The underlying conductive fabric provides an additional level of conductivity to those imparted by the patterned conductive layer.

The electrically conductive yarns will typically have a resistivity of between 0.001 and 100 ohms per inch. The conductive fabric may also include non-conductive fibers or yarns, including but not limited to man-made fibers such as polyethylene, polypropylene, polyesters (polyethylene terephthalate, polybutylene terephthalate, polytrimethylene terephthalate, polylactic acid, and the like, including copolymers thereof); nylons (including nylon 6 and nylon 6,6); regenerated cellulosics (such as rayon or Tencel); elastomeric materials such as Lycra; and high-performance fibers such as the polyaramids, polyimides, PEI, PBO, PBI, PEEK, liquid-crystalline, thermosetting polymers such as melamine-formaldehyde (Basofil) or phenol-formaldehyde (Kynol) and the like. The non-conductive materials may also include natural fibers such as cotton; coir; bast fibers such as linen, ramie, and hemp; proteinaceous materials such as silk, wool, and other animal hairs such as angora, alpaca, or vicuna. The non-conductive yarns may also be basalt, glass, or ceramic. Blends of man-made fibers, natural fibers, or both types of fibers are anticipated.

The conductive fabric 100 comprising elastomeric non-conductive yarns may be preferred because they give the article, such as a garment, stretch for comfort to the wearer. The combination of a patterned conductive layer 120 with the conductive fabric 100 is important when using elastic yarns in the conductive fabric because when the fabric is stretched cracks and discontinuities are likely to form in the conductive material of the patterned conductive layer 120.

In one embodiment, the conductive fabric 100 comprises electrically conductive plated yarns. Preferably, the yarns are plated with silver, aluminum, copper, or nickel. These metals have been shown to have relatively high conductivity and tend to form protective oxide coatings upon corrosion. Preferably, the yarns have a linear resistance of between 1 and 100 ohms per inch.

In another embodiment, the conductive fabric 100 comprises yarns comprised of fibers that are coated with an electrically conductive polymer. Preferably, the electrically conductive polymer of the invention is selected from the group consisting of substituted or unsubstituted aniline containing polymers, substituted or unsubstituted pyrrole containing polymers, and substituted or unsubstituted thiophene containing polymers. The above polymers provide the desired conductivity and adhesion to yarns.

In yet another embodiment, the conductive fabric 100 comprises wires or wire-wrapped yarns woven or knitted into the fabric. The electrically conductive wires may be wrapped around a non-conductive core yarn or around a conductive core.

In another embodiment, the conductive fabric 100 comprises a non-conductive fabric which is treated to be conductive. This may include, for example, a non-conductive fabric being coated with a conductive material or a non-conductive fabric with a plated layer of metal. Preferably, the fabric is plated with silver, aluminum, copper, or nickel. These metals have been shown to have relatively high conductivity and tend to form protective oxide coatings upon corrosion. Preferably, the fabric has a surface resistance of between 0.01 and 100 ohms.

The conductive fabric 100 has at least 2 buses 110. The buses may be on either side of the conductive fabric 100, i.e., on the same side of the conductive fabric 100 as the patterned conductive layer 120 or opposite the patterned conductive layer 120. Usually, the buses are found on or near opposite edge regions of the conductive fabric. The conductive buses 910 are in electrical contact with the conductive fabric 100 and conduct electricity from the power source onto the electric heated element 10.

Any suitable method may be used to form the buses. For example, the buses 110 may, at least in part, be applied in the form of a conductive paste applied in a shape using screen printing or other known means of applying coatings to fabric. The conductive buses may be formed in the shape of a strip, localized dots, or regions. The conductive buses 110 may have the form of a wire, e.g., stranded, twisted, braided, woven, or knitted configurations and may be attached to the surface of the conductive fabric 100 by stitching, embroidery stitching, or sewing. The conductive fabric 100 and conductive buses 110 may also be connected electrically by conductive solder or paste; rivets, snaps, adhesives, lamination, or metal holders or fasteners; interlacing, knitting or weaving in, or combinations of the above. The conductive bus 110 is preferably flexible, corrosion resistant, and mechanically durable, with low electrical resistivity, e.g., 0.001 ohm per meter to 100 ohm per meter. The conductive buses 110 preferably have a higher electrical conductivity than the conductive fabric 100 and the patterned conductive layer 120. In one embodiment, the conductivity of the conductive buses 110 is 10 times greater than the conductivity of the patterned conductive layer 120. Other considerations include cost, availability in the market, and ease of fabrication.

The conductive buses 110 may also have similar or different lengths, and the resistance of the individual conductive bus elements may be different.

The patterned conductive layer 120 is electrically connected to the conductive fabric 100 and is located between the at least 2 conductive buses 110. Physical degradation or deformation of the patterned conductive layer 120 on the conductive fabric 100 has less of an impact on the overall heat generating properties of the electric heated element 10 than if the patterned conductive layer 120 were made on a non-conducting textile.

In one embodiment, the patterned conductive layer 120 comprises a conductive paste in an optional thickener such that the final mixture has adequate viscosity to hold a shape when applied to the fabric. Typically, the conductive paste consists of graphite, silver-coated particles, or silver particles in a polymeric binder, and the thickener is any of a variety of commercially available screen-printing thickeners. A combination of different materials, typically graphite and silver, may be used to better tailor both the conductivity and mechanical properties (such as stretch, flexibility, and adhesion) of the layer. In another embodiment, the patterned conductive layer is formed from inkjet printing using a conductive material that is inkjet printable. Inkjet printing and other forms of printing conductive materials allow for variable designs, shapes, materials, and thicknesses of the conductive layer. Use of computer-controlled printing that lays down the conductive coating pixel-by-pixel permits the printed pattern to be easily changed for each article so printed. This allows for flexible manufacturing of garments and for short runs to be done economically.

In another embodiment, the patterned conductive layer 120 may be an additional conductive fabric, cut or formed in a pattern and electrically connected to the first conductive fabric 100.

In another embodiment, the patterned conductive layer 120 comprises an embroidery layer disposed on and electrically connected to the conductive fabric. The embroidery layer comprises conductive yarns. In another embodiment, the patterned conductive layer 120 comprises a patterned metallic layer. This may be accomplished using masking, where the desired pattern is formed in a mask and the metal is applied through the mask. Masking is a way to quickly and inexpensively create the metallic pattern and the metal can be applied through the mask using a technique such as screen printing or vacuum deposition.

In some embodiments, the conductive layer may be discontinuous. It may everywhere have the same surface resistance, or it may have different surface resistances in different areas, either connected or discontinuous. The different surface resistances can be made through the use of different materials, regions of different thickness, different types of layers, or combinations of these, in the manners described above.

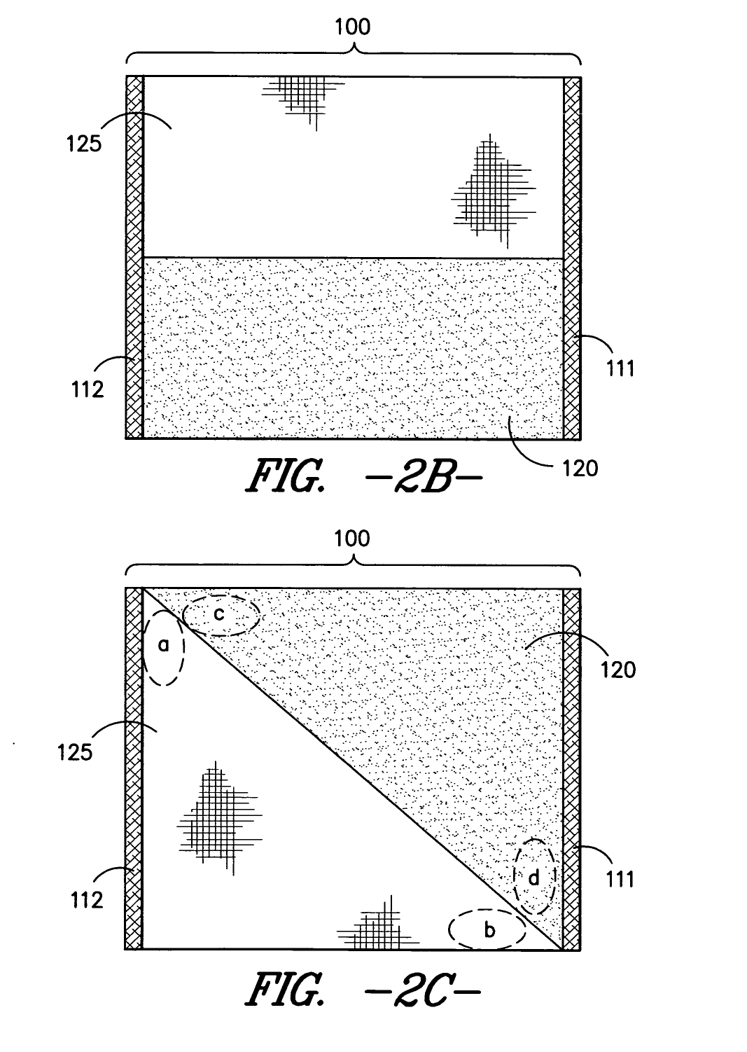

Preferably, the patterned conductive layer 120 has a lower resistivity than the conductive fabric 100. The effects of the lower resistivity can be illustrated through three simplified examples, shown in FIGS. 2A, 2B, and 2C.

FIG. 2A, one embodiment of the invention, shows conductive fabric 100 with first bus 111 and second bus 112 and patterned conductive area 120, where patterned conductive area 120 covers one half of conductive fabric 100 adjacent to first bus 111. Unpatterned area 125 has the same surface resistance r1 as conductive fabric 100, while patterned conductive area 120 has a lower surface resistance r2. In this case, patterned conductive area 120 is electrically in series with unpatterned area 125, so the total current I through both areas must be equal. The power generated in each area is I²R, where the surface resistance R=r*(L/W). Because r1>r2, the surface resistance R1>R2, and consequently the power generated across R1, in unpatterned area 125, is greater than the power generated across R2, in patterned conductive area 120. As a result, unpatterned area 125 will generate more heat than patterned conductive area 120.

In contrast to the above configuration, FIG. 2B shows conductive fabric 100 where patterned conductive area 120 extends across one half of conductive fabric 100 from first bus 111 to second bus 112. In this case, patterned conductive area 120 is electrically in parallel with unpatterned area 125, so the total voltage V across both areas must be equal. The power generated in each area is now given by V²/R. Once again r1>r2, and the surface resistance R1>R2. However, as a result of the parallel construction, the power generated across R1, in unpatterned area 125, is now less than the power generated across R2, in patterned conductive area 120. Consequently, unpatterned area 125 will now generate less heat than patterned conductive area 120.

These two examples show that applying a patterned conductive area of lower resistivity to a conductive fabric can cause the patterned conductive area to be either hotter or cooler than the unpatterned area, depending on the relative configuration of buses and patterned conductive areas.

Another configuration is shown in FIG. 2C, in which conductive patterned conductive area 120 covers half of conductive fabric 100 on one side of a diagonal, so that it is completely adjacent to first bus 111 and just touches second bus 112 in one corner. In this case, patterned conductive area 120 is neither completely in series nor in parallel with unpatterned area 125. Because patterned conductive area 120 has a lower surface resistance than unpatterned area 125, more current will flow through patterned conductive area 120 through unpatterned area 125 from first conductive bus 111 to second conductive bus 112. As a result, current density will be higher through sub-region a than through sub-region b, both contained in unpatterned area 125. Since the surface resistance of both sub-regions a and b are the same, the power density will be much higher in sub-region a than in sub-region b. As a result, sub-region a will get much hotter than sub-region b.

Similar reasoning can be used to argue that the current density in sub-region c will be about equal to that in sub-region a, and much larger than that in sub-region d, in which it will be about equal to that in sub-region b. Thus, sub-region c will get much hotter than sub-region d. However, since the surface resistance of patterned conductive area 120 is lower than that of unpatterned area 125, the heat generated in sub-region c will be less than that in sub-region a, and the heat generated in sub-region d will be less than that in sub-region b. The result of this pattern is that heat generation can be directed to one corner of fabric 100 (sub-region a) as opposed to another (sub-region b), and it can directed to one area (unpatterned area 125) as opposed to another (patterned conductive area 120).

Heating patterns of even greater complexity can be created using more complex patterned conductive areas such as shown in FIG. 1.

The greater the difference in the resistivities of the patterned and unpatterned areas, the greater the effects described above. In one embodiment, the patterned conductive layer has 10 times less resistivity than the conductive fabric 100.

For simplicity, in the examples above the resistivity was assumed to be constant throughout the patterned conductive area. In another embodiment, the thickness of the patterned conductive layer 120 varies across the conductive fabric 100. This serves to create varying resistivity, and therefore varying heat generation, using the same material. In another embodiment, the materials vary across the patterned conductive layer 120. By using different materials (with different resistivities), the amount of resistivity varies across the patterned conductive layer 120, creating areas of differing heat generation.

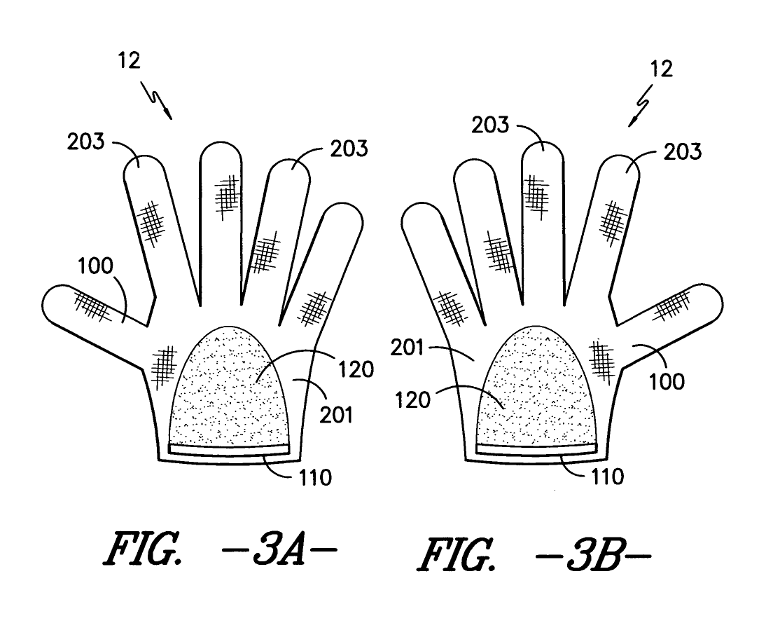

In one embodiment, the electric heated article is a heated glove 12. An example is illustrated in FIGS. 3A and 3B, which show the two sides of the glove before being attached. The heated glove generally has a palm region 201 and 5 fingers 203. The patterned conductive layer 120 tailors the heat generation across the glove 12 for user comfort. For example, the finger areas 203 of the glove 12 may require more heat generation than the palm region 201. The patterned conductive layer 120 has a lower resistivity than the unpatterned fabric. Using the illustrated patterns, current and subsequently heat will be directed more towards the middle and ring fingers and less towards the thumb, index, and little fingers than would be the case in the absence of patterned conductive layer 120. Also, less heat will be generated in the portions of palm region 201 that is covered by patterned conductive layer 120 than would be generated in its absence. In one embodiment, at least 90% of the patterned conductive layer resides in the palm region 201.

The electric heated article 10 is electrically connected to a power source to supply electrical power for heat generation. Electricity may be applied in many methods, including but not limited to alternating or direct current from a household outlet, a cigarette lighter or other power outlet of an automobile, or from a battery pack. Additional alternative power sources include photovoltaic panels and fuel-cells.

The conductive fabric 100 may be treated to be hydrophobic. Additionally, in one embodiment, barrier layers may be applied to the outside surfaces of the electric heated article 10. The barrier layers can serve to isolate the electric heated article 10 from the environment or water and to electrically insulate the electric heated article 10. Preferably, the barrier layer is made of polyvinyl chloride, polyurethane, silicone, neoprene, or other known barrier layers with the desired physical characteristics.

### EXAMPLES

The examples are a comparative example to illustrate the benefit of our invention.

First, a 2-bar Raschel knit fabric was constructed using 40 dpf polyester cationic multifilament yarn and 40 dpf multifilament spandex elastomeric yarn. In the center 16 inches of the fabric, 40 dpf X-static 1/40-xs-13 silver-coated nylon conductive filament yarn from Sauquoit Industries, Inc. of Scranton, Pa. was substituted for the polyester multifilament yarn. This created edge panels of non-conductive fabric and a center panel of conductive fabric with physical properties virtually identical to those of the non-conductive edge panels.

Example 1 was a 6″×8″ sample cut from the center conductive panel. For examples 2 and 3 a conductive paste using 25 mL PE-001 silver ink available from Acheson Colloids Company of Port Huron, Mich., was mixed with 1 ml Printrite® 495 available from Noveon, Inc. of Cleveland, Ohio.

The conductive paste was applied to 6″×8″ areas on both the conductive portion of the fabric and an adjoining non-conductive portion of the fabric by screen printing. The ink was cured 7 minutes at 110° C. The weight of the conductive ink after curing was about 7.5 oz/yd² on the conductive base fabric and about 5.9 oz/yd² on the non-conductive base fabric.

Example 2 is a comparative example of conductive coating on the non-conductive fabric. Example 3 is a comparative example of conductive coating on the conductive fabric.

Resistance measurements were made using a four-point probe. It can be difficult to obtain resistance measurements on conductive textiles, even using the four-point probe method, due to the variability of the contact resistance with pressure due to the inherent 3-dimensionality of the textile structure. An attempt was made to maintain uniform pressure during measurements. Measurements were taken initially, then after stretching the fabric. The fabric was manually stretched 50% in each direction (machine direction (MD) and cross-machine direction (CD)) to simulate expected use. Resistance measurements were taken after 1,10, and 20 stretches of the fabric.

Before stretching, Example 1 measured approximately 145 milliohms/square in the cross-machine direction, and about 99 milliohms/square in the machine direction. The measurement did not change appreciably with stretching.

Before stretching, Example 2 measured approximately 52 milliohms/square in the machine direction and about 700 milliohms/square in the cross-machine direction. Upon stretching, the printed area was observed to develop numerous visible cracks. After a single stretch, no conductivity was measured in the cross-machine direction, and the conductivity in the machine direction had decreased by a factor of 10. After 10 stretches, the conductivity in the machine direction had decreased by a factor of 100, where it appeared to level out.

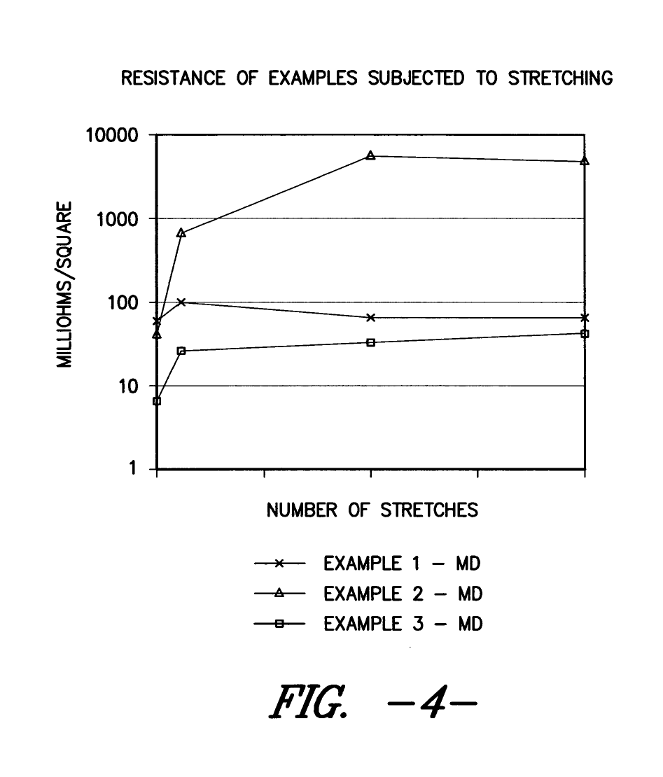

Before stretching, Example 3 measured approximately 6 milliohms/square in the machine direction and 6.6 milliohms/square in the cross-machine direction. Upon an initial stretch, the conductive print also was observed to crack, but the conductivity decreased only by a factor less than 5. After multiple stretches, the conductivity was observed to have decreased by a factor of 7 or less, and the decrease appeared to have leveled off. After the stretch testing, the resistance of the printed area averaged about 38 milliohms/square, which is more conductive than the conductive fabric alone (Example 1), which averaged about 80 milliohms/square. Thus, despite the fact that the print paste was observed to crack on the surface of the textile, a higher degree of conductivity was maintained for the printed region than the base conductivity of the fabric itself, in contrast to Example 2, where there was a substantial loss of conductivity of the print. The results are summarized in Table 1 below. The results for the machine direction are shown graphically in FIG. 4.

TABLE 1
Resistivity of examples subjected to stretching

| | | Resistivity, Measured in Milliohm/square | | | |
|---|---|---|---|---|---|
| | | | After 1 | After 10 | After 20 |
| | | Initial | Stretch | stretches | Stretches |
| Example 1 | MD | 99 | 78 | 61 | 61 |
| | CD | 145 | 67.5 | 100.5 | 100 |
| Example 2 | MD | 52 | 660 | 6500 | 5500 |
| | CD | 700 | Not | Not | Not |
| | | | measurable | measurable | measurable |
| Example 3 | MD | 6.0 | 28.5 | 36 | 43 |
| | CD | 6.6 | 22.5 | 29 | 33.5 |

It is intended that the scope of the present invention include all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art from the foregoing description of the preferred embodiments without departing from the spirit or scope of the present invention.

1. An electric heating element comprising a conductive fabric, a patterned conductive layer on at least a first side of the conductive fabric, and at least 2 conductive buses on the conductive fabric, wherein the patterned conductive layer is disposed between the buses.

2. The electric heating element of claim 1, wherein the conductive fabric comprises a knit.

3. The electric heating element of claim 1, wherein the conductive fabric comprises conductive yarns.

4. The electric heating element of claim 1, wherein the conductive fabric comprises elastic yarns.

5. The electric heating element of claim 1, wherein the conductive fabric comprises conductive yarns and nonconductive yarns.

6. The electric heating element of claim 1, wherein the conductive fabric comprises electrically conductive plated yarns.

7. The electric heating element of claim 1, wherein the buses have higher electrical conductivity than the patterned conductive layer.

8. The electric heating element of claim 1, wherein the buses are located on the first side of the conductive fabric.

9. The electric heating element of claim 1, wherein the patterned conductive layer comprises silver.

10. The electric heating element of claim 1, wherein the patterned conductive layer comprises electrically conductive particles in a polymeric binder.

11. The electric heating element of claim 1, wherein the patterned conductive layer comprises an inkjet printable conductive material printed onto the conductive fabric.

12. The electric heating element of claim 1, wherein the patterned conductive layer comprises an additional conductive fabric electrically connected to the conductive fabric.

13. The electric heating element of claim 1, wherein the patterned conductive layer comprises an embroidery layer substantially disposed on and electrically connected to the first conductive fabric.

14. The electric heating element of claim 1, wherein the patterned conductive layer comprises a patterned metallic layer plated onto the surface of the conductive fabric.

15. The electric heating element of claim 1, wherein patterned conductive layer thickness varies across the conductive fabric.

16. The electric heating element of claim 1, wherein the patterned conductive layer comprises different materials across the conductive fabric.

17. The electric heating element of claim 1, wherein the patterned conductive layer comprises electrically disconnected regions.

18. The electric heating element of claim 17, wherein the electrically disconnected regions have substantially equal surface resistances.

19. The electric heating element of claim 17, wherein the electrically disconnected regions have different surface resistances.

20. The electric heating element of claim 1, wherein the electric heating element has regions of differing resistivity between the buses.

21. The electric heating element of claim 1, wherein the patterned conductive layer has a lower resistivity than the conductive fabric.

22. The electric heating element of claim 21, wherein the patterned conductive layer has a resistivity of at least 10 times less than the resistivity of the conductive fabric.

23. The electric heating element of claim 1, wherein the electric heating element is a heated garment.

24. A heated glove comprising a first conductive fabric, a patterned conductive layer on at least a first side of the conductive fabric, and at least 2 buses on the conductive fabric, wherein the patterned conductive layer is disposed between the at least 2 buses.
